(19) United States
(12) Patent Application Publication
(10) Pub. No.: US 2015/0373130 A1
(43) Pub. Date: Dec. 24, 2015

(54) DEVICE AND METHOD FOR CONNECTING CELEBRITIES AND FANS

(71) Applicant: SHOWER TECH S.L., Madrid (ES)

(72) Inventors: Enrique Hormigo Pérez, Madrid (ES); Bernardo Eugenio Bienz, Madrid (ES); Rafael Eugenio Amigo Quintana, Madrid (ES); Eduardo De Frutos, Madrid (ES)

(21) Appl. No.: 14/746,589

(22) Filed: Jun. 22, 2015

Related U.S. Application Data
(60) Provisional application No. 62/015,145, filed on Jun. 20, 2014.

(51) Int. Cl. H04L 29/08

(52) U.S. Cl. CPC H04L 67/18; H04L 67/10

(57) ABSTRACT

Various aspects described herein relate to connecting fans and celebrities in a social networking environment. A fan profile can be associated with a celebrity profile in the social networking environment. Attendance of a device registered for the fan profile at an event defined for the celebrity profile can be determined. An opportunity for the fan profile to obtain an autograph related to the celebrity profile can be provided based at least in part on the determined attendance of the device. Distributions of locations or times related to the autograph and/or other autographs can be provided.

### CROSS-REFERENCE

The present application incorporates by reference the following patent application: U.S. Ser. No. 62/015145 filed Jun. 20, 2014 entitled “Method and System for connecting celebrities and fans”.

### TECHNICAL FIELD

The technical field relates to computer systems and methods. More particularly, the technical fields relates to digital media systems, devices and methods.

### BACKGROUND

Social networks have evolved over the last few years to connect many people worldwide through varying degrees of relationships. Some social networks require users to be mutually indicated as friends before content is shared between the users. Thus, typically, the users know of one another or at least have a mutual contact before connecting or otherwise one party may not desire to connect with the other. Other types of social networks allow users to “follow” one another without such requirements to observe content posted by the users via the social networks. In these social networks, there is typically no mutuality between users following one another. This model of social networks that lacks requirement of a mutual relationship is used today by many celebrities to communicate with fans, where the fans can essentially be anyone that determines to “follow” the celebrity on the social network. In this model, however, fans typically remain anonymous to the celebrities, and the celebrities have no way within the social network to acknowledge fan dedication or otherwise distinguish among fans. Similarly, in this model, fans have no way to achieve and share acknowledgement of dedication with respect to the celebrities.

Otherwise, networked devices, such as wireless phones with a wireless network connection, tablet devices, computers and networked set-top boxes, allow viewers to access content through communication channels other than traditional air or cable TV. For instance, networked devices are often configured with an interface or application to allow viewers to access content over a communication network like Internet. Therefore, it is desirable to use networked devices to easy connect fans and celebrities without interfering the privacy of the celebrity and without to obstruct the direct communication between the parties.

### SUMMARY OF THE INVENTION

The invention is related to connecting fan and celebrity profiles in a social networking environment such that allow fans to obtain acknowledgement from the celebrities for fan dedication, such as in the form of an autograph or other personalized acknowledgement in the social networking environment.

It is an object of the invention to provide a system and method arranged to fan attendance at an event defined for the celebrity profile can be determined, and an opportunity to receive an autograph from the celebrity profile can be provided, to the fan profile based on detecting the fan attendance at the event. For example, the opportunity for the autograph may be provided based on a variety of parameters or other events, such as the celebrity profile indicating that he/she will sign autographs at the event and a fan dedication ranking of the fan profile among fan profiles for the celebrity, among other parameters or events. In any case, the celebrity profile can provide the autograph to the fan profile at the event (e.g., based on meeting the fan or otherwise), and the fan profile can share the autograph with other friends to which the fan is connected within the social networking environment.

The autograph provided by the celebrity profile may include a photo or video, a personalized message, and scribe of the celebrity's signature (e.g., using an electronic pen, touchscreen, etc.), and/or the like. In an example, the celebrity profile can indicate one or more parameters of fan profiles at the event that can be considered in determining for which fan profiles to generate one or more autographs. In addition, the fan profile or the celebrity profile may determine a number of autographs by the celebrity profile over a period of time, a number of autographs by the celebrity profile based on a geographic location of the autographs, a probability of obtaining an autograph from the celebrity based on parameters of the fan profile and/or of an event, and/or the like.

More concretely a method for connecting fans and celebrities in a social networking environment, comprises: associating a fan profile with a celebrity profile m the social networking environment; determining attendance of a device registered for the fan profile at an event defined for the celebrity profile; and providing an opportunity for the fan profile to obtain an autograph related to the celebrity profile based at least in part on the determined attendance of the device.

The device according with the invention is a portable electronic device comprising a touch screen, at least a processor, at least a memory, and at least one computer application stored in said memory and configured to be executed by the processor on an operating system, and where said application includes instructions for: associating a fan profile with a celebrity profile in the social networking environment; determining attendance of a device registered for the fan profile at an event defined for the celebrity profile; and providing an opportunity for the fan profile to obtain an autograph related to the celebrity profile based at least in part on the determined attendance of the device registered for the fan profile.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an example system for connecting celebrities and fans, m accordance with aspects of the present disclosure.

FIG. 2 illustrates an example methodology for providing fans with opportunities to obtain celebrity autographs, in accordance with aspects of the present disclosure.

FIG. 3 illustrates an example methodology for providing location and/or time information regarding autographs provided by a celebrity, in accordance with aspects of the present disclosure.

FIG. 4 illustrates an example methodology for determining a probability of a fan receiving an autograph at a celebrity event, in accordance with aspects of the present disclosure.

FIG. 5 is an example system diagram of various hardware components and other features, for use in accordance with aspects described herein.

FIG. 6 is a block diagram of various example system components, for use in accordance with aspects described herein.

FIG. 7 is a block diagram of an example of a portable device for use in accordance with aspects described herein.

### DETAILED DESCRIPTION OF THE INVENTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used herein, the term “determining” or “evaluating” encompasses a wide variety of actions. For example, “determining” and “evaluating” may include calculating, computing, processing, deriving, investigating, looking up (e.g., looking up in a table, a database or other data repository, or another data structure), ascertaining, and/or the like. Also, “determining,” and “evaluating” may include receiving (e.g., receiving information), accessing (e.g., accessing data in a data repository), and/or the like. Also, “determining” may include resolving, selecting, choosing, establishing, and the like.

As used herein, the terms “element,” “module,” “component,” and “system” may refer to a computer-related entity, either hardware, a combination of hardware and software, software, or software in execution. For example, a module may be, but is not limited to being, a machine-executable process running on a processor, a processor, an object, a thread of execution, a machine-executable program, and/or a computer. By way of illustration, both a process running on a server and the server may be a module or a component. One or more modules or components may reside within a process and/or thread of execution. In some implementations, a module may be localized on one computer and/or distributed among two or more computers.

It will be appreciated that, in accordance with one or more aspects described herein, inferences may be made regarding determining protocols to provide to the application, analyzing data for performance of the protocols, and/or the like, as described. As used herein, the term to “infer” or “inference” refers generally to the process of reasoning about or inferring states of the system, environment, and/or user from a set of observations as captured via events and/or data. Inference may be employed to identify a specific context or action, or may generate a probability distribution over states, for example. The inference may be probabilistic-that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Various aspects or features will be presented herein in terms of systems that may include a number of devices, components, modules, and the like. It is to be understood and appreciated that the various systems may include additional devices, components, modules, etc. and/or may not include all of the devices, components, modules, etc., discussed in connection with the figures. A combination of these approaches may also be used.

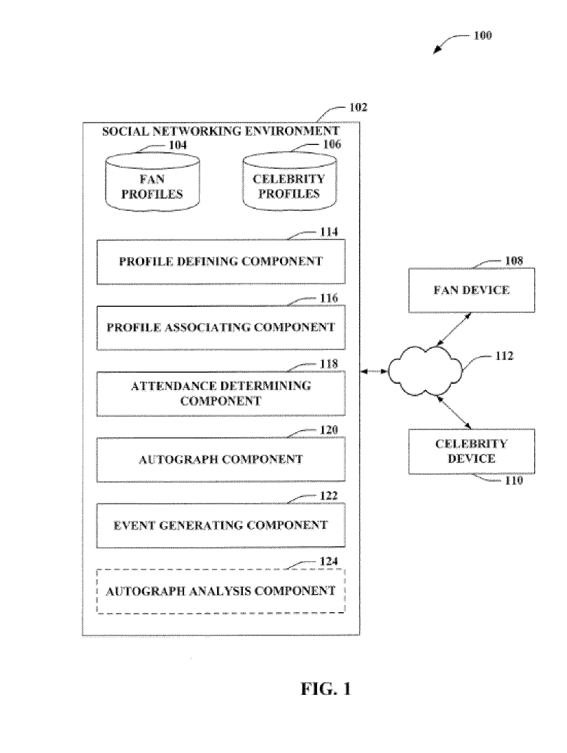

Referring to FIG. 1, an example system 100 is illustrated for connecting fan profiles and celebrity profiles in a social networking environment 102. Social networking environment 102 can store a plurality of fan profiles 104 and celebrity profiles 106 (e.g., in separate data stores or the same data store) that may be associated with one another in the social networking environment 102. For example, one or more fan profiles in fan profiles data store 104 can be associated, linked, or otherwise connected with other fan profiles and/or celebrity profiles in celebrity profiles data store 106. In one example, linking among fan profiles can be of a different type than linking among fan and celebrity profiles (e.g., linking between fan profiles may be based on mutual friendship indication whereas linking between fan profiles and celebrity profiles may be based on the fan profile “following” the celebrity profile). The profiles may be associated such that one profile can view content posted by another profile in the social networking environment 102.

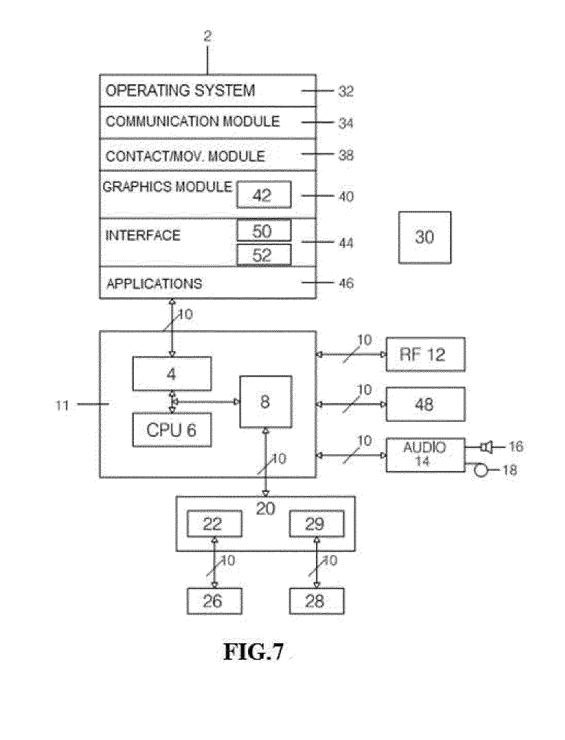

System 100 also includes a fan device 108 and a celebrity device 110 that can access social networking environment 102 via a network 112 (e.g., the Internet) to view social networking content related to a fan profile of the fan device 108 or a celebrity profile of the celebrity device 110. Devices 108 and 110 may be substantially any device that can connect to a social networking environment via a network, such as a terminal, as described herein, which may include a computer, smartphone, tablet, etc. A practical example can be found in FIG. 7. Devices 108 and 110 can communicate with social networking environment 102 to register profiles, associate with other profiles, create autograph, create events, specify event attendance, share autographs, analyze autograph statistics of a celebrity, and/or the like, as described further herein.

Social networking environment 102 includes a profile defining component 114 for generating a fan or celebrity profile for storing in fan profile data store 104 or celebrity profile data store 106, a profile associating component 116 for associating one or more profiles with one another, an attendance determining component 118 for detecting attendance of a device related to a fan profile at an event created by a celebrity profile, and an autograph component 120 for providing an opportunity to receive a generated autograph or other personalized message, picture, video, etc., for a celebrity profile to provide to a fan profile. Social networking environment 102 also includes an event generating component 122 for creating an event notification relating to an event that a celebrity plans to attend, and/or an optional autograph analysis component 124 for analyzing autograph statistics or other information of autographs generated for a celebrity profile to determine a number of autographs specific to a period of time, a location, etc., a probability of obtaining an autograph, and/or the like.

According to an example, fan device 108 and/or celebrity device 110 may access social networking environment 102 to create a profile therewith. For example, profile defining component 114 can provide an interface to fan device 108 and/or celebrity device 110 for generating the profile, where the interface may include various input fields allowing for specifying profile data described above. In addition, profile defining component 114 may allow accessing social networking environment 102 and/or profile definition based on a profile of the fan in another social networking environment. Profile associating component 116 can allow the fan device 108 to associate the fan profile with one or more other fan profiles (e.g., friend profile(s)) and/or one or more celebrity profiles. For example, profile associating component 116 can store information linking the fan profile to the other fan profiles and/or celebrity profiles, such as an identifier corresponding to the profiles and/or the like to facilitate retrieving content associated with the other fan profiles and/or celebrity profiles to display for the registering fan profile. For example, when fan device 108 connects to social networking environment 102, the social networking environment 102 pro vides the fan device with content related to associated fan profiles (e.g., friends) and celebrity profiles.

In one example, celebrity device 110 can create an event via event generating component 122 for associating with the celebrity profiles. Thus, fan profiles associated to the celebrity profiles may obtain information regarding the generated event for providing for display on fan device 108, such to notify the fan profile of the event. If the fan attends the event, an opportunity may be provided to receive an autograph from the celebrity. In this regard, for example, attendance determining component 118 can determine whether one or more fan devices 108 related to fan profiles associated to the celebrity profile are present at the event. For example, fan device 108 may notify social networking environment 102 of a device location during the event (e.g., using one or more geolocation technologies at the fan device 108, such as global positioning system (GPS), global navigation satellite system (GLONASS), base station triangulation, and/or the like). It is to be appreciated that, though similarly numbered, fan device 108 used to register with the social networking environment 102 and used in attendance of an event may be different devices, where both devices are associated with the same fan profile. In addition, in an example, attendance determining component 118 can be part of the one or more devices, such as celebrity device 110, that can detect attendance of the fan device 108 based on determining a proximity thereto (e.g., via geolocation on both devices, Bluetooth or near field communication detection, etc.).

In an example, autograph component 120 may provide an opportunity for the fan profile to receive an autograph from the celebrity based at least in part on attendance determining component 118 detecting attendance of the fan device 108 at event. For example, where celebrity device 110 initiates autograph signings, autograph component 120 may present celebrity device 110 with one or more fan profiles present at the event, as determined by attendance determining component 118. Autograph component 120 can allow celebrity device 110 to select one or more fan profiles to which to provide an autograph. Thus, for example, autograph component 120 can provide the celebrity device 110 with details of the one or more fan profiles (e.g., fan name, location, residence, etc.) for generating the autograph.

In addition, autograph component 120 can generate statistics for the fan profile related to the celebrity profile, such as a length of time the fan profile has been associated with the celebrity profile, how many (if any) autographs have been received from the celebrity for the fan profile, number of events of the celebrity profile attended by the fan profile, length of time spent at the events, social media mentions of the celebrity by the fan profile, and/or the like. In one example, autograph component 120 can present such statistics to the celebrity device 110 and/or can generate fan ranking, dedication score, or similar metric from the statistics for providing to the celebrity device 110. In this regard, autograph component 120 may additionally present celebrity device 110 with a ranked list of fans according to the fan ranking or dedication score. The list may be sorted or otherwise also take into consideration whether the fan has received an autograph in the past, etc.

In this regard, celebrity device 110 may determine one or more fan profiles to which to provide an autograph. In an example, the celebrity device 110 may notify the fan device 108 of an autograph opportunity. The autograph opportunity may include an opportunity to meet the celebrity at a location (e.g., for a picture), or may include the autograph itself without a meeting. Celebrity device 110 can be used to generate the autograph by interfacing with autograph component 120 to receive a signature on the celebrity device 110 (e.g., via electronic pen, touchscreen, etc.). In another example, where the fan meets the celebrity in person, the fan device may be used to interface with autograph component 120 to receive the celebrity's signature on the fan device, an associated picture, video, etc., and/or the like. In any case, autograph component 120 can store the autograph in the fan profile (e.g., in fan profile data store 104) or celebrity profile (e.g., in celebrity profile data store 106 for linking to the fan profile). Social networking environment 102 can share the autograph or an indication of receiving the autograph with other fan profiles (e.g., friends) in the social networking environment.

In addition, autograph component 120 can store or otherwise provide access to autograph statistics for a celebrity, such as time/date of an autograph, location where one or more autographs were provided, a fan profile for which the autograph was provided, etc., and autograph analysis component 124 can provide one or more analyses related to the autograph statistics. For example, autograph analysis component 124 can determine a number of autographs provided to fan profiles over a period of time and can cause fan device 108 and/or celebrity device 110 to display this information. In another example, autograph analysis component 124 can determine a number of autographs provided to fan profiles at one or more locations, and may display the locations via fan device 108 and/or celebrity device 110 (using a list of locations, an indication of a number of autographs for one or more of the locations, a density map or other visual indicator of the number of autographs per location, etc.).

In another example, autograph analysis component 124 can provide a fan device 108 with a probability of receiving an autograph from a celebrity at a current or upcoming event, which can be computed based on one or more determinations regarding previous autographs provided by the celebrity. For example, autograph analysis component 124 may compute one or more parameters based on previous autographing by the celebrity device (based on data recorded by autograph component 120), such as location of the event, profile information of the fans (including age, gender, location, birthplace, residence, interests, etc.), and may compare the parameters to similar parameters of the current or upcoming event as well as the fan profile to determine the probability of receiving an autograph. Substantially any statistical calculation may be used, which may include weighting parameters that are similar among previous signings and the upcoming event and fan profile. For example, the parameters may include distance from the residence of the fan to the event location, number of times the fan has tried to get the autograph attending the scheduled event location and gone without it, weather at the time of the meeting, waiting time at the event location, physical distance to the event location (e.g., in meters) between the fan and the celebrity, emulating a “first row”, interaction with the celebrity at social networking (re-tweets, likes, etc . . . ), number of hits on content by the fan (e.g. on fan device 108 or another device that accesses the fan profile), acquisition of certain products previously by the fan (e.g. on fan device 108 or another device that accesses the fan profile), participation in campaigns of third parties (sponsors) or contests (e.g. on fan device 108 or another device that accesses the fan profile), depreciation of fan factor, age, gender, etc., and also, random effects.

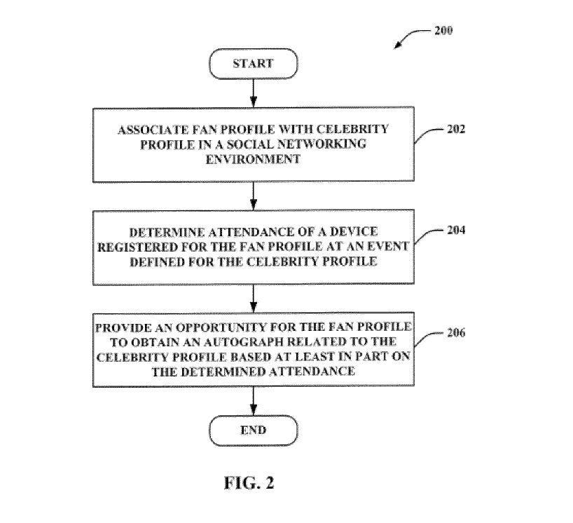

Referring to FIGS. 2-4, example methodologies for connecting fans and celebrities are illustrated. While, for purposes of simplicity of explanation, the methodologies are shown and described as a series of acts, it is to be understood and appreciated that the methodologies are not limited by the order of acts, as some acts may, in accordance with one or more variations in implementation, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more variations.

Referring to FIG. 2, an example methodology 200 that facilitates providing opportunities for fans to obtain celebrity autographs is illustrated.

At 202, a fan profile can be associated with a celebrity profile in a social networking environment. As described, the fan profile and celebrity profile can be generated in the social networking environment, and can be associated such that the fan profile can indicate a connection to the celebrity profile, receive content from the celebrity profile, etc. In addition, events can be created relating to the celebrity profile (e.g., where the celebrity plans to attend the event).

At 204, attendance of a device registered for the fan profile at an event defined for the celebrity profile can be determined. For example, attendance can be determined based on determining a location for the device registered to the fan profile at a time during which the event is occurring, based on detection of the device in a proximity of the a celebrity device, etc.

At 206, an opportunity for the fan profile to obtain an autograph related to the celebrity profile can be provided based at least in part on the determined attendance. Thus, for example, the celebrity device may initiate an autograph signing process to determine one or more fans profiles to which to provide an autograph. In this regard, the celebrity device may determine to provide the autograph to the fan profile, and the fan profile may be contacted to determine whether the autograph is accepted, to setup a meeting point or event location with the celebrity for the signing to occur, etc. In examples described herein, the celebrity device may determine to provide the autograph to the fan profile based on determining a fan dedication score, ranking, etc., whether the fan profile has received an autograph in the past, and/or the like. Moreover, in an example, it is to be appreciated that the fan profile may be provided with opportunities to receive multiple celebrity autographs at a given event.

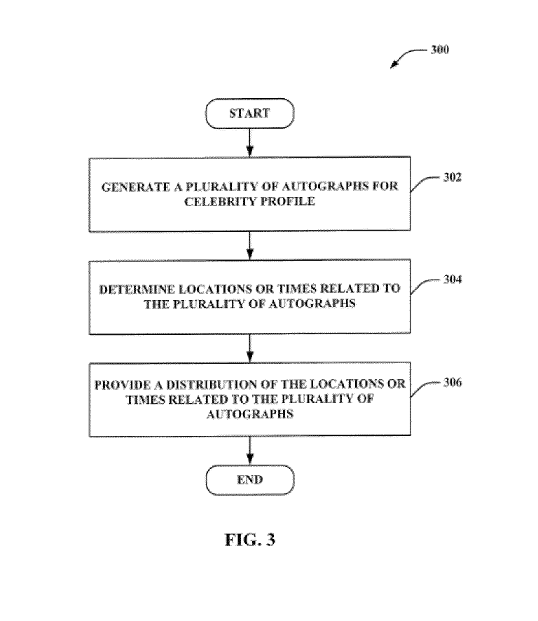

Turning to FIG. 3, an example methodology 300 is shown for indicating information regarding previous autographs.

At 302, a plurality of autographs are generated for a celebrity profile. As described, the autographs can be generated in accordance with methodology 200 (FIG. 2). In this regard, one or more parameters regarding the autographs can be stored, such as location, time, fan profile to which the autograph is provided, and/or the like.

At 304, locations or times related to the plurality of autographs can be determined. For example, location or time data can be collated for the autographs and may be modified so as to indicate a distribution of the location or time data.

Thus, at 306, a distribution of the locations or times related to the plurality of autographs can be provided. This can be in the form of a list of times or locations (e.g. sorted according to highest number of autographs first), a density map visually indicating the number of autographs at various locations, and/or the like.

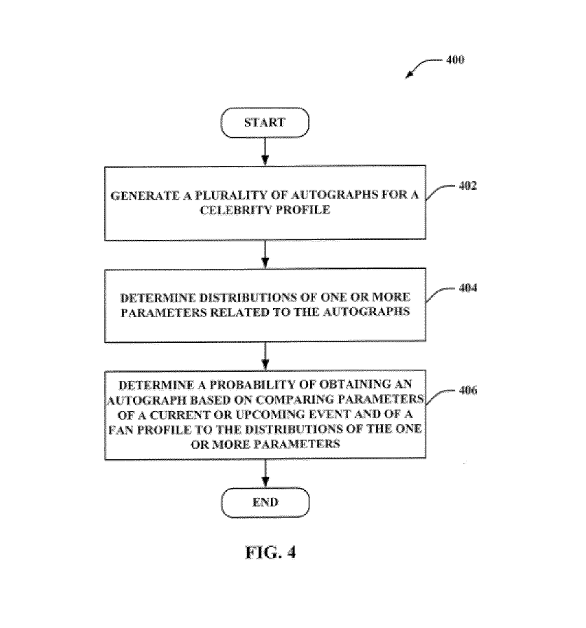

Turning to FIG. 4, an example methodology 400 is shown for determining a probability of obtaining an autograph at a current or upcoming event.

At 402, a plurality of autographs are generated for a celebrity profile. As described, the autographs can be generated in accordance with methodology 200 (FIG. 2). In this regard, one or more parameters regarding the autographs can be stored, such as location, time, fan profile to which the autograph is provided, and/or the like.

At 404, distributions of one or more parameters related to the autographs are determined. For example, this can include evaluating similar parameters of the autographs to determine the distributions, such as a number or percentage of autographs related to a certain location, distance from a fan device, age or gender of the fan, number of events attended by a fan before an autograph was received, weather at the time of the event, etc., as described above.

At 406, a probability of obtaining an autograph can be determined based on comparing parameters of a current or upcoming event and of a fan profile to the distributions of the one or more parameters. For example, the probability can be computed by weighting certain parameters that are common among the parameter distributions and parameters of the current or upcoming event, parameters of the fan profile, etc. The probability can be provided to the fan device, for example.

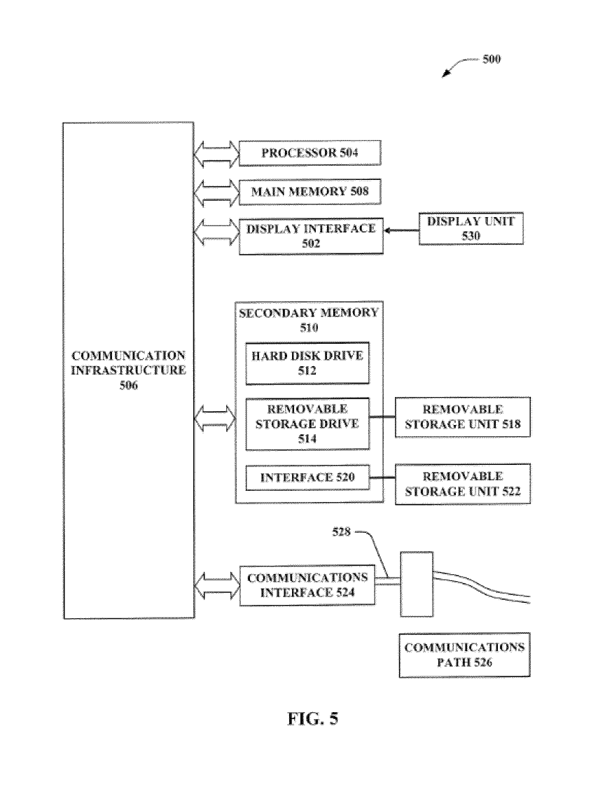

In some variations, aspects described herein may be directed toward one or more computer systems capable of carrying out the functionality described herein. An example of such a computer system 500 is shown in FIG. 5.

Computer system 500 may include one or more processors, such as processor 504. The processor 504 is connected to a communication infrastructure 506 (e.g., a communications bus, cross-over bar, or network). Various software aspects are described in terms of this example computer system. After reading this description, it will become apparent to a person skilled in the relevant art(s) how to implement the described subject matter using other computer systems and/or architectures.

Computer system 500 may include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, a flash memory drive, etc. The removable storage drive 514 reads from and/or writes to a removable storage unit 518 in a well-known manner. Removable storage unit 518, represents a floppy disk, magnetic tape, optical disk, flash memory card, etc., which is read by and written to removable storage drive 514. As will be appreciated, the removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 514, a hard disk installed in hard disk drive 512, and signals 528. These computer program products provide software to the computer system 500. Aspects of the described subject matter may be directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the subject matter described herein. In particular, the computer programs, when executed, enable the processor 504 to perform the features of the described subject matter. Accordingly, such computer programs represent controllers of the computer system 500.

In an aspect where the aspects described herein are implemented using software, the software may be stored in a computer program product and loaded into computer system 500 using removable storage drive 514, hard disk drive 512, or interface 520. The control logic (software), when executed by the processor 504, causes the processor 504 to perform the functions of the subject matter described herein. In another aspect, the subject matter described herein may be implemented primarily in hardware using, for example, hardware components, such as application specific integrated circuits (ASICs). Implementation of the hardware state machine so as to perform the functions described herein will be apparent to persons skilled in the relevant art(s). In yet another aspect, variations of the described subject matter may be implemented using a combination of both hardware and software.

In one example, display interface 502 may provide interfaces related to the devices 108 and 110, such as the graphical user interfaces that can display data related to functions described herein. Interaction with these interfaces may be provided via input devices connected to communication infrastructure 506, such as a keyboard, mouse, touch screen, voice input, and/or the like.

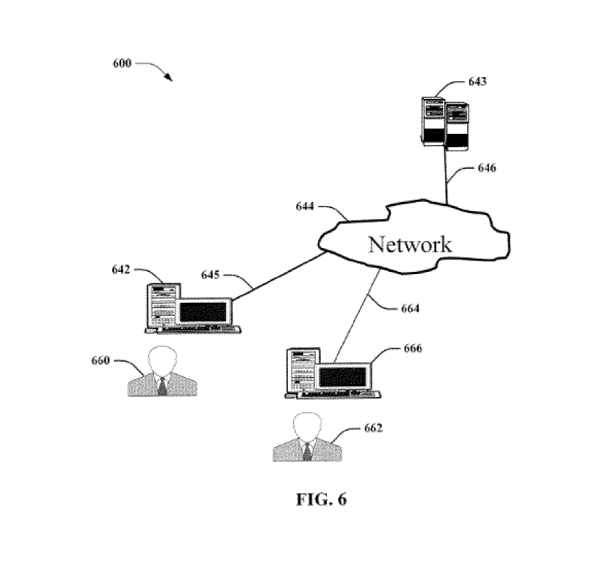

FIG. 6 shows a communication system 600 involving use of various features in accordance with aspects described herein. The communication system 600 may include one or more assessors 660, 662 (also referred to interchangeably herein as one or more “users”, “entities,” etc.) and one or more terminals 642, 666 accessible by the one or more access 660, 662. In one aspect, operations in accordance with aspects described herein may include, for example, input and/or accessed by an access 660 via terminal 642, such as personal computers (PCs), minicomputers, mainframe computers, microcomputers, telephonic devices, or wireless devices, such as personal digital assistants (“PDAs”), cellular phones, smartphones, tablets, or a hand-held wireless devices coupled to a remote device 643, such as a server, PC, minicomputer, mainframe computer, microcomputer, or other device having a processor and a repository for data and/or connection to a repository for data, via, for example, a network 644, such as the Internet or an intranet, and couplings 645, 664. The couplings 645, 664 include, for example, wired, wireless, or fiber optic links. In another aspect, the methods and systems described herein may operate in a stand-alone environment, such as on a single terminal.

Various examples of graphical user interfaces providing functions described herein as well as specific interfaces that may be used in some examples to provide functions described herein. It is to be appreciated that these interfaces are examples and substantially any interface or interacting mechanism can be used to achieve functions described herein. Said graphical interfaces can be programmed in a portable electronic device, more concretely in a portable electronic device used as fan device 108 and celebrity device 110.

FIG. 7 illustrates a portable electronic device, according to a practical embodiment of the invention both for the fan device 108 and the celebrity device 110. The portable electronic device (108,110) includes a memory 2, a memory controller 4, at least a processor 6 (a central processing unit, CPU), a peripherals interface 8, RF circuitry 12, audio circuitry 14, a speaker 16, a microphone 18, an input/output (I/O) subsystem 20, a touch screen 26, other input or control elements 28, and an external port 48. These components communicate over the one or more communication buses 10.

The portable electronic device can be any, including, although not limited to, mobile phones, tablets, laptops and in general any portable electronic device comprising at least a touch screen with which interacts with the user, and with a capacity to run applications or computer software on an operating system. The various elements of the portable electronic device (108,110) may be implemented in hardware, software or a combination of both, including all the necessary elements, such as application specific integrated circuits and signal processing means.

The memory 2 may include a high speed random access memory and/or a non-volatile memory. In some embodiments, said memory may further remotely located, communicating through a communications network which is not shown.

The peripherals interface 8 couples the input and output peripherals of the device (108,110) to the CPU 6 and the memory 2. The CPU processor 6 runs various software applications and/or set of instructions stored in said memory 2 to perform various functions for the device (108,110) and to process data.

The touch screen 26 provides an output interface and an input interface between the device and a user. The controller 22 of the touch-screen 26 receives and sends the electrical signals from/to the above touch screen 26 which displays the visual output to the user. This visual output may include text, graphics, video, and any combination thereof. This visual output includes part or all the applications resident on the mobile device (108,110).

The touch screen 26 also accepts input from the user based on contact, since it forms a touch-sensitive surface that accepts user input. The touch screen 26 and the touch screen controller 22 (along with any associated modules and/or sets of instructions in the memory 2) detects contact (and any movement or break of the contact) on the touch screen 26 and converts the detected contact into interaction with user-interface objects, such as one or more soft keys, that are displayed on the touch screen. By way of example, a point of contact between the touch screen 26 and the user corresponds to one or more digits of the user. The touch screen 26 and the touch screen controller 22 can detect the contact and any movement or lack thereof using any one of a plurality of contact sensitivity technologies. The touch screen 26 may have a resolution in excess of 100 dpi. The user may make contact with the touch screen 26 using any suitable object or appendage, such as a stylus, finger, and so forth.

The device (108,110) also includes a power system 30 for the various components. The software components include an operating system 32, a communication module, or set of instructions, 34, a contact/motion module, or set of instructions, 38, a graphics module, or set of instructions, 40, a user interface state module, or set of instructions, 44, and one or more applications, or set of instructions, 46.

The contact/motion module 38 may detect contact with the touch screen 26 in conjunction with the touch screen controller 22. The contact/motion module 38 includes various software components for performing various operations related to detection of contact with the touch screen 22, such as determining if contact has occurred, determining if there is movement of the contact and tracking the movement across the touch screen, and determining if the contact has been interrupted (that is, if the contact has ceased). Determining movement of the point of contact may include determining speed (magnitude), velocity (magnitude and direction), and/or an acceleration (including a change in magnitude and/or direction) of the point of contact.

The graphics module 40 includes various known software components for rendering and displaying graphics on the touch screen 26. Note that the term “graphics” includes any object that can be displayed to a user, including without limitation text, web pages, icons (such as user-interface objects including soft keys), digital images, videos, animations and the like.

The graphics module 40 includes an optical intensity module 42. The optical intensity module 42 controls the optical intensity of graphical objects, such as user-interface objects, displayed on the touch screen 26. Controlling the optical intensity may include increasing or decreasing the optical intensity of a graphical object. In some embodiments, the increase or decrease may follow predefined functions.

The user interface state module 44 controls the user interface state of the device (108,110). The user interface state module 44 may include a lock module 50 and an unlock module 52. The lock module detects satisfaction of any of one or more conditions to transition the device (108,110) to a user-interface lock state and to transition the device (108,110) to the lock state. The unlock module detects satisfaction of any of one or more conditions to transition the device to a user-interface unlock state and to transition the device (108,110) to the unlock state. Further details regarding the user interface states are described below. The one or more applications 30 include any applications installed on the device (108,110).

The device (108,110) is a device where operation of a predefined set of functions on the device is performed exclusively through the touch screen 26. By using the touch screen as the primary input/control device for operation of the device (108,110), the number of physical input/control devices (such as push buttons, dials, and the like) on the device (108,110) may be reduced. The predefined set of functions that are performed exclusively through the touch screen and the touchpad include navigation between user interfaces.

While the foregoing has been described in conjunction with the example aspects outlined above and further described in the figures, various alternatives, modifications, variations, improvements, and/or substantial equivalents, whether known or that are or may be presently unforeseen, may become apparent to those having at least ordinary skill in the art. Accordingly, the exemplary aspects, as set forth above, are intended to be illustrative, not limiting. Various changes may be made without departing from the spirit and scope of the subject matter described herein. Therefore, this disclosure is intended to embrace all known or later-developed alternatives, modifications, variations, improvements, and/or substantial equivalents.

What is claimed is:

1. A method for connecting fans and celebrities in a social networking environment, comprising:
associating a fan profile with a celebrity profile in the social networking environment;
determining attendance of a device registered for the fan profile at an event defined for the celebrity profile; and
providing an opportunity for the fan profile to obtain an autograph related to the celebrity profile based at least in part on the determined attendance of the device.

2. The method of claim 1, further comprising:
processing the autograph from a device registered for the celebrity profile; and associating the autograph with the fan profile.

3. The method of claim 2, further comprising notifying a friend profile related to the fan profile of the autograph related to the celebrity profile.

4. The method of claim 1, further comprising:
determining locations related to a plurality of autographs of the celebrity profile; and
displaying an indication of the locations on a density map.

5. The method of claim 1, further comprising:
determining one or more autograph parameters related to previous autographs of the celebrity profile; and
comparing one or more parameters related to the fan profile or the event to the one or more autograph parameters to determine a probability of obtaining the autograph for the fan profile.

6. The method of claim 1, further comprising displaying a number of autographs related to the celebrity profile.

7. The method of claim 1, further comprising determining a ranking of the fan profile for the celebrity profile based at least in part on past attendance of devices related to the fan profile at events defined by the celebrity profile.

8. The method of claim 1, further comprising determining a ranking of the fan profile for the celebrity profile based at least in part on social media content generated by the fan profile relating to the celebrity profile.

9. A portable electronic device for connecting fans and celebrities in a social networking environment comprising:
a touch screen,
at least a processor,
at least a memory, and
at least one computer application stored in said memory and configured to be executed by the processor on an operating system, and wherein said application includes instructions for:
associating a fan profile with a celebrity profile in the social networking environment;
determining attendance of a device registered for the fan profile at an event defined for the celebrity profile; and
providing an opportunity for the fan profile to obtain an autograph related to the celebrity profile based at least in part on the determined attendance of the device registered for the fan profile.

10. The device of claim 9 further comprising instructions for processing the autograph from a device registered for the celebrity profile; and associating the autograph with the fan profile.

11. The device of claim 10, further comprising instructions for notifying a friend profile related to the fan profile of the autograph related to the celebrity profile.

12. The device of claim 9, further comprising instructions for:
determining locations related to a plurality of autographs of the celebrity profile; and
displaying an indication of the locations on a density map.

13. The device of claim 9, further comprising instructions for:
determining one or more autograph parameters related to previous autographs of the celebrity profile; and
comparing one or more parameters related to the fan profile or the event to the one or more autograph parameters to determine a probability of obtaining the autograph for the fan profile.

14. The device of claim 9 further comprising instructions for displaying a number of autographs related to the celebrity profile.

15. The device of claim 9, further comprising instructions for determining a ranking of the fan profile for the celebrity profile based at least in part on past attendance of devices related to the fan profile at events defined by the celebrity profile.

16. The device of claim 9, further comprising instructions for determining a ranking of the fan profile for the celebrity profile based at least in part on social media content generated by the fan profile relating to the celebrity profile.
